(19) United States
(12) Patent Application Publication
(10) Pub. No.: US 2008/0189776 A1
(43) Pub. Date: Aug. 7, 2008

(54) Method and System for Dynamically Controlling Access to a Network

(75) Inventor: Colin Constable, Surrey (GB)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(73) Assignee: Credit Suisse Securities (USA) LLC, New York, NY (US)

(21) Appl. No.: 12/024,905

(22) Filed: Feb. 1, 2008

Related U.S. Application Data
(60) Provisional application No. 60/899,276, filed on Feb. 1, 2007.

(51) Int. Cl. H04L 9/32; G06F 7/04

(52) U.S. Cl. 726/7

(57) ABSTRACT

The dynamic access evaluation system receives a service request from a device seeking access to a network. The system receives information about the requester, the device from which the request is made and/or the location of the requester and the device. The system analyzes rule sets for the application being requested on the network to determine whether authentication is necessary. The system authenticates the requester based on a comparison of authorization information to information about the requester received in the request. The system authenticates the device by comparing device information in the request to historical device information. Furthermore, the system receives location information for the device and the requester and compares them to determine whether the locations are the same or similar. After granting access, the system continues to monitor information about the requester, device, or location and can terminate device access based on a change in the monitored information.

### RELATED PATENT APPLICATION

This patent application claims priority under 35 U.S.C. §119 to U.S. Provisional Patent Application No. 60/899,276, entitled “Dynamic Security Control” and filed Feb. 1, 2007, the complete disclosure of which is hereby fully incorporated herein by reference.

### FIELD OF THE INVENTION

The invention relates generally to security methods and architecture for an enterprise-wide network. More specifically, the invention relates to systems and methods of dynamic security to determine whether a service request will be accepted into the network.

### BACKGROUND

As the Internet has grown, companies have struggled to adapt methods of making their computing networks secure from unauthorized users. Companies have focused development efforts on the security of their private networks. In an effort to make these networks more secure, many companies implemented firewalls, log-in barriers, security tokens, and other methods known to those of ordinary skill in the art in an attempt to grant only authorized personnel access to the enterprise network. While public users may have been given access to some portions of the company's network, a great deal of it was restricted to employees, and in most cases, employees only had access to specific portions of the network.

Over time, technologies for making a company's network more accessible via the Internet have been developed. One significant area of development is in the area of off-site access through the use of virtual private networks, wireless access and WiFi, just to name a few. These technologies make it easier for employees to access the resources of the company's network from virtually anywhere. Such access has allowed for increased employee productivity. In addition, the ability to share information between companies, without providing access to the public in general, has improved the ability for companies to outsource services while still maintaining the information on a secure network.

However, the technologies currently used to make it easier to access a company's network have several drawbacks. The advent of increased accessibility has also made it easier to access these networks by those who mean to do it harm, through spoofing, piggy-backing, and other known methods of unauthorized access to a network. Furthermore, conventional technologies do not provide for a way to continue to monitor a device or party accessing the network to determine if changes occur in the device or the party accessing the network which would necessitate a reevaluation of whether to continue allowing the device to access to the network. Hence, one a person logs in from a device and is granted access to the system, the access continues until the device or party chooses to log off the network. Thus, if the party who was granted access steps away from the device without logging off, any other person would continue to have access to the network irrespective of whether that person should be permitted access. In addition, conventional technologies do not monitor the location of the device or person accessing the network to determine if the access is permitted based on location.

Accordingly, there is a need in the art for a product and method that allows for dynamic security of an enterprise-wide network by determining whether a service request will be accepted or rejected based on an analysis of the person, device characteristics, and location from which the request originated. The present invention solves these and other needs in the art.

### SUMMARY OF THE INVENTION

The dynamic access evaluation system can receive a service request from a device seeking access to the network. In one exemplary embodiment the request is for access to an application or service provided on the network. The system can receive information about the person making the request (the “requester”), the device from which the request is made and/or the location of the requester and the device. Further, the system can analyze one or more sets of rules for the application or service being requested to determine whether authentication of the requester, the device and/or the location is necessary. The system can access an authorization database to accept a listing of users who have access to the requested application or service. In addition, the authorization database can provide user log-in information. The system can compare information about the requester received in the request to information about the requester in the authorization database to determine whether the information is the same or similar. The system can also receive information about the device making the request and compare it to historical information about the device to determine whether the device is authentic or if the device has been changed in such a way that allowing it to access the network falls outside the rules of the requested application or service. Furthermore, the system can receive location information for the device and the requester as part of the request or in addition to the request. The location information for the device and the requester can be compared to determine whether they are in the same or similar location. In addition, after granting access to the network, the system can continue to monitor information about the requester, the device, or the location and can terminate the device's access to the network based on a change in the monitored information that violates a rule of the service or application being accessed by the device.

For one aspect of the present invention, the dynamic access evaluation system can receive a request for access to the network from a requester at a device. The dynamic access evaluation system can receive authentication information for the requester. In one exemplary embodiment, the authentication information can be included with the request for access or in a separate transmission to the dynamic access evaluation system. The dynamic access evaluation system can retrieve authorization information about the requester from an authorization database. The authorization information can include, but is not limited to, information regarding the people who are permitted to access the network or particular services or applications on the network. The dynamic access evaluation system makes a comparison of the authentication information to the authorization information to determine whether the requester is authentic. In one exemplary embodiment, the requester is authentic if the authentication information and the authorization information are the same or substantially similar. An authentication score can then be generated by the dynamic access evaluation system based on the comparison of the authentication information to the authorization information. The policy engine can use the authentication score to determine whether to grant the device access to the network.

For another aspect of the present invention, the dynamic access evaluation system can receive a request for access to the network from a device. The dynamic access evaluation system can also receive information about the device making the request. In one exemplary embodiment, the information about the device can be included with the request for access to the network or a part of a separate transmission to the dynamic access evaluation system. The dynamic access evaluation system can compare the device information to historical device information. In one exemplary embodiment, the historical device information includes, but is not limited to, computer assets and information related to each of those assets, including device types, device serial numbers, memory allotment for each device, and operating system levels for each device. the dynamic access evaluation system can determine whether the device is authentic based on the comparison of the device information to the historical device information. It can then generate an authentication score based on the comparison. A determination whether to grant the device access to the network can then be made based on the authentication score.

For yet another aspect of the present invention, the dynamic access evaluation system can receive a request for access to the network from a requester at a device. The dynamic access evaluation system can further receive the location of the device and the requester. In one exemplary embodiment, the location of the device and/or the requester can be included in the initial request or a part of a separate transmission to the dynamic access evaluation system. In another exemplary embodiment, the location of the requester can be determined based on presence feeds, biometric data or other devices that are independent of the request being made by the device to access the network. The dynamic access evaluation system can compare the location of the device to the location of the requester to determine whether they are the same or substantially similar. In one exemplary embodiment, the location of the device may be more general than the location of the requester, or vice-versa. The location could be deemed substantially similar if the more specific location is within the area of the less specific location. In an alternative embodiment, the location could be deemed substantially similar if the location of the device is within a predetermined distance of the location of the requester, including, but not limited to fifty feet, one-hundred feet, five hundred feet, one-thousand feet, one-half mile, or one mile. Access can be granted for the device to access the network based on a determination that the device an the location of the requester are the same or substantially similar.

For a further aspect of the present invention, the evaluation system can include a first logic component for receiving information about a requester using a device and determining the authenticity of the requester. The system can also include a second logic component for receiving information about the device make the request to access the network and determine whether the device is authentic. In addition, the system can include a third logic component for receiving information about the location of the device and the location of the requester and determining whether the location of the device and the requester are the same or substantially similar, as described hereinabove.

### BRIEF DESCRIPTION OF THE DRAWINGS

For a more complete understanding of the present invention and the advantages thereof, reference is now made to the following description in conjunction with the accompanying figures in which:

FIG. 1 is a block diagram illustrating an exemplary operating environment for implementation of various embodiments of the present invention;

FIG. 2 is a flowchart illustrating a process for verifying the identity of the person making a service request in accordance with an exemplary embodiment of the present invention;

FIG. 3 is a flowchart illustrating a process for verifying the identity of the device from which a service request is made in accordance with an exemplary embodiment of the present invention; and

FIG. 4 is a flowchart illustrating a process for verifying the location of the device and person making the service request in accordance with an exemplary embodiment of the present invention; and

### DESCRIPTION OF THE INVENTION

The present invention supports a computer-implemented method and system for conducting dynamic security of a service request from an agent to determine whether the service request will be accepted into the network. Exemplary embodiments of the present invention can be more readily understood by reference to the accompanying Figures. Although exemplary embodiments of the present invention will be generally described in the context of a software and hardware modules and an operating system running on a network, those skilled in art will recognize that the present invention can also be implemented in conjunction with other program modules for other types of computers. Furthermore, those skilled in the art will recognize that the present invention may be implemented in a stand-alone or in a distributed computing environment. Furthermore, those skilled in the art will recognize that the present invention may be implemented in computer hardware, computer software, or a combination of computer hardware and software.

In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the global Internet.

The detailed description that follows is represented largely in terms of processes and symbolic representations of operations by conventional computing components, including processing units, memory storage devices, display devices, and input devices. These processes and operations may utilize conventional computer components in a distributed computing environment.

The processes and operations performed by the computer include the manipulation of signals by a processing unit or remote computer and the maintenance of these signals within data structures resident in one or more of the local or remote memory storage devices. Such data structures impose a physical organization upon the collection of data stored within a memory storage device and represent specific, electrical or magnetic elements. The symbolic representations are the means used by those skilled in the art of computer programming and computer construction to most effectively convey teachings and discoveries to others skilled in the art.

Exemplary embodiments of the present invention include a computer program and/or computer hardware that embodies the functions described herein and illustrated in the Figures. It should be apparent that there could be many different ways of implementing the invention in computer programming, including, but not limited to, application specific integrated circuits (“ASIC”) and data arrays; however, the invention should not be construed as limited to any one set of the computer program instructions. Furthermore, a skilled programmer would be able to write such a computer program to implement a disclosed embodiment of the present invention without difficulty based, for example, on the Figures and associated description in the application text. Therefore, disclosure or a particular set of program code instructions is not considered necessary for an adequate understanding of how to make and use the present invention. The inventive functionality of the computer program will be explained in more detail in the following description and is disclosed in conjunction with the remaining Figures.

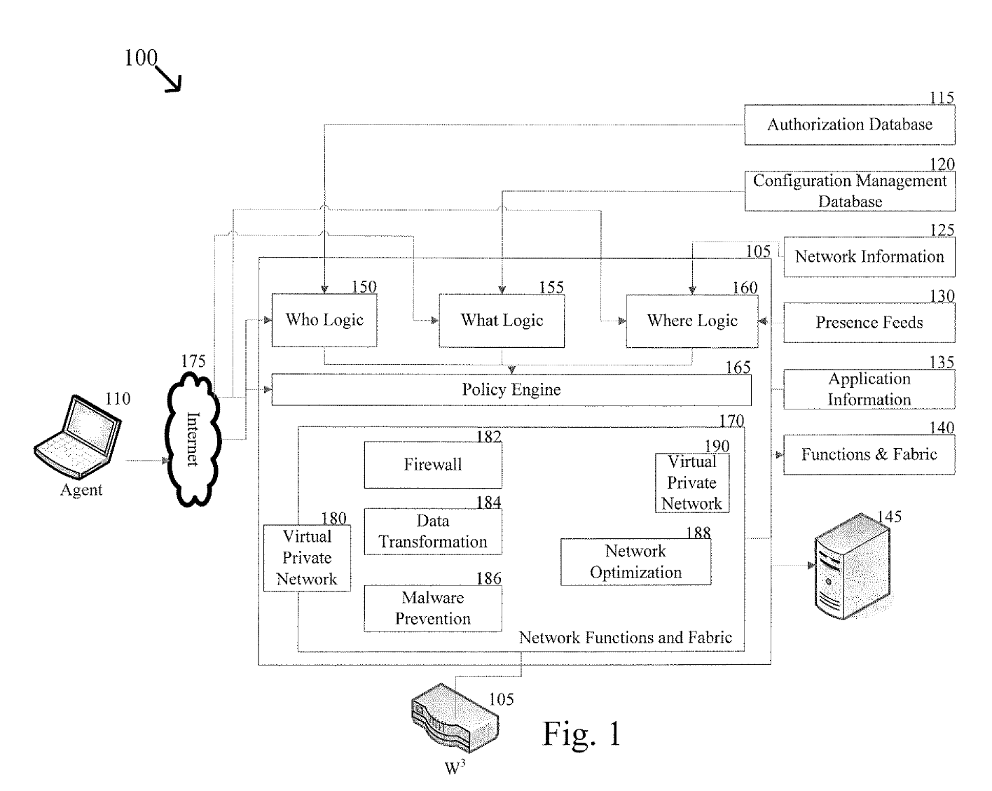

Referring now to the drawings, in which like numerals represent like elements throughout the several Figures, aspects of the present invention and an exemplary operating environment for the implementation of the present invention will be described. FIG. 1 is a block diagram illustrating an exemplary system-level architecture 100 for implementing a dynamic security control process in accordance with an exemplary embodiment of the present invention. Now referring to FIG. 1, the exemplary system 100 comprises a Who, What, Where (“W3”) device 105, an authorization database 115, a configuration management database 120, network information 125, presence feeds 130, application information 135, network functions & fabric 145, and an agent 110. The exemplary W3 device 105 includes Who Logic 150, What Logic 155, Where Logic 160, a policy engine 165, and network functions and fabric 170. In one exemplary embodiment, the W3 device 105 is located on the edge of the network between the internal and external data centers of a corporation. In another exemplary embodiment, one or more W3 devices 105 can be positioned between the functions and fabric 145 of one or more enterprise data centers within a corporation.

The Who Logic 150 is communicably connected via a distributed computer network to the authorization database 115 and the policy engine 165. In one exemplary embodiment, the authorization database 115 stores information regarding the people who are permitted access to particular services on the network. Examples of an authorization database 115 include a AAA server and a radius database. The exemplary Who Logic 150 determines if a person is allowed to have access to an application or service in the protected network.

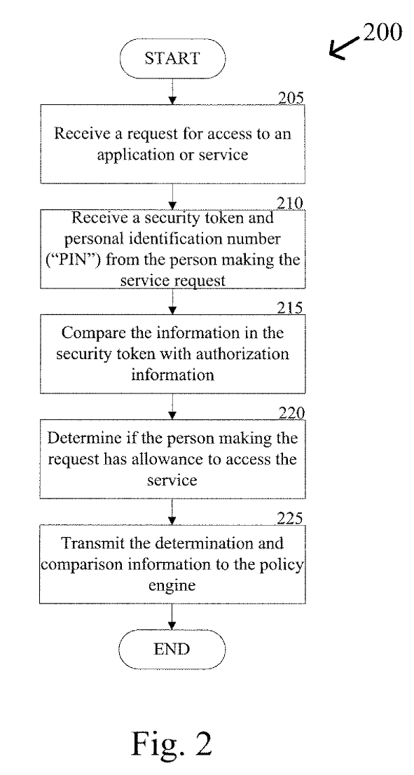

FIG. 2 presents an exemplary process for determining whether a person is allowed to have access to the network as completed by the Who Logic 150 in the W3 device 105 of FIG. 1. The exemplary process 200 of FIG. 2 begins at the START step and proceeds to step 205, where the W3 device 105 receives a request for access to an application or service (a “service request”). In one exemplary embodiment, the request is part of an XML feed (or any other type of known transmission feed) received by the policy engine 165 via the Internet 175 and passed to the Who Logic 150. In an alternative embodiment, the request is part of an XML feed received by the Who Logic 150 from the agent 110 via the Internet 175. In step 210, a one or two-factor authentication of the requester at the agent 110 is received by the Who Logic 150 as part of the service request. In one exemplary embodiment, a two-factor authentication includes a security identification, such as a security token, and a personal identification number (“PIN”); however, other authentication methods, such as biometrics could be used in addition to or in place of the security token or PIN.

The Who Logic 150 cross-references the security token or the security token and PIN with information in the authorization database 115 in step 215. In step 220, the Who Logic 150 determines if the requesting party has access to the service being requested. In one exemplary embodiment, the Who Logic 150 makes its determination by comparing the information in the security token to information in the authorization database 115 and determining whether the information is the same or substantially similar based on a set of rules in the Who Logic 150. In one exemplary embodiment, the set of rules includes a look-up of a user database (not shown) that lists known users that are allowed to use the service. In step 225, the information obtained by the Who Logic 150 is transmitted to the policy engine 165 where it may undergo further analysis.

In one exemplary embodiment, the policy engine 165 evaluates the received information from the Who Logic 150 and the information in the service request and calculates how much the information from the Who Logic 150 is trusted or how much the information from the Who Logic 150 needs to be trusted as part of the policy engine's 165 determination of whether to allow the service request to connect. For example, rules of the policy engine 165 could require for a particular request biometric confirmation of the Who Logic 150 using an iris scanner or a fingerprint in addition to swipe card evidence that the person is in a building and global positioning system data from a cell phone as well as voiceprint confirmation on a secured telephone line located in the banks vault. In addition, the rule could require that the device being used has to be clear of viruses and malware and must be using an encrypted hard drive.

While the requester is connected, the policy engine 165 monitors the connectivity and the information feeds and responds to any detected changes according to the rules. Using the example above, if the policy engine 165 receives information that the requester has swiped out of the bank vault, or that the requester's identity has changed, as determined by the Who Logic 150, then the policy engine 165 would terminate the connection between the requester and the system. The process continues from step 225 to the END step.

The What Logic 155 is communicably connected via a distributed computer network to the configuration management database 120, and the policy engine 165. The exemplary configuration management database 120 is a repository of all of the computer assets, and information related to each of those assets, that are owned or managed by an organization. Device types, device serial numbers, memory allotment for each particular device, and operating system levels for each device are examples of information that can be included in the configuration management database 120. The exemplary What Logic 155 determines whether the device from which a service request is coming from is the same or substantially similar to the device characteristics stored in the configuration management database 120.

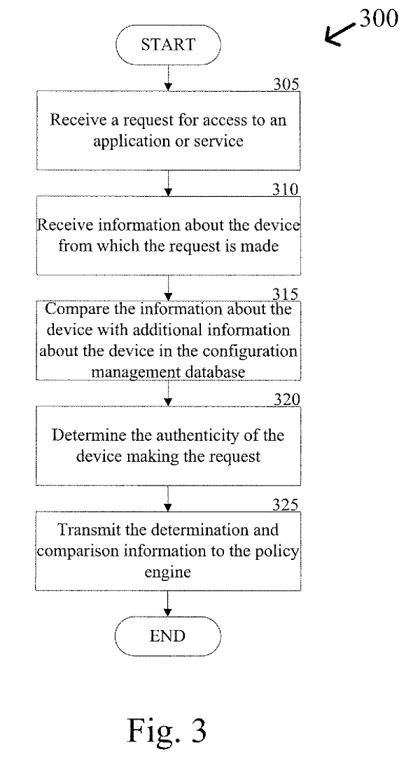

FIG. 3 presents an exemplary process for determining whether a device presenting the service request is authentic and therefore allowed to have access to the network as completed by the What Logic 155 in the W3 device 105 of FIG. 1. The exemplary process 300 of FIG. 3 begins at the START step and proceeds to step 305, where the W3 device 105 receives a request for access to an application or service. In one exemplary embodiment, the request is part of an XML feed received by the policy engine 165 from an agent 110 via the Internet 175 and passed to the What Logic 155. In an alternative embodiment, the request is part of an XML feed (or any other type of known transmission feed) received by the What Logic 155 from the agent 110 via the Internet 175. In step 310, the What Logic 155 receives from the agent 110 information about the device on which the request is being made. This information received from the agent 110 may include fingerprint data of the device or an arithmetic hash of the data on the device. In one exemplary embodiment, the fingerprint data of the device includes one or more of the following: serial numbers, device configuration (including memory installed, central processing unit speed, etc.). the health of the device (including whether malware or viruses are installed on the device), whether the hard drive is encrypted, and if a BIOS password or PIN are used on the device.

The What Logic 155 cross-references information about the device received from the agent 110 with information on the configuration management database 120 to determine whether the device specifications are the same or substantially similar in step 315. The What Logic 155 makes a determination about the authenticity of the device that is allegedly making the request in step 320. In step 325, the information obtained by the What Logic 155 can then be passed to the policy engine 165 where it may be further analyzed. For example, a user makes a service request from a personal computer. Information obtained from the configuration management database 120 says that the computer that the request was made from has 500 megabytes of random access memory while the information from the agent 110 says that the computer has one gigabyte of random access memory. The What Logic 155 could decide if access should be denied or if the difference does not rise to the level of significance necessary for denying a service request based on the rules set forth in the What Logic 155, or it could pass this information to the policy engine 165 so that the policy engine 165 can make the access determination. The process continues from step 325 to the END step.

The Where Logic 160 is communicably connected via a distributed computer network to the network information 125, presence feeds 130, and the policy engine 165. In one exemplary embodiment, the Where Logic 160 attempts to determine the location of the device from which a service request is being made and uses the location information to determine whether the requester will have access to the requested service. The network information 125 provides information that allows the Where Logic 160 to ascertain where the agent 110 is in a radio network, private network, or on the Internet 175.

In one exemplary embodiment, the location of the agent 110 may be determined by way of a radio network through the use of a radio signal to and from the device to pinpoint the location of the device, similar to that being used for location detection in E911 systems. Wifi access points provide another example of the use of radio signals to determine the location of a device. In another exemplary embodiment the location of a request from an agent 110 over the Internet 175 can be determined by the Where Logic 160 receiving the handle or IP address of the request. The Where Logic 160 can compare the IP address to conventional databases that link IP addresses with detailed location information worldwide. For requests being made in a private network, the Where Logic 160 can, for example, receive the IP address and compare the address to an internal database of IP addresses and their location within the private network.

Presence feeds 130 attempt to use data to determine where a person is physically located, what that person is doing at a particular time, and/or if they are available. Presence feeds 130 can include information streams and databases of data related to the location of a person making the request. One example of a presence feed 130 is a building swipe card, which can be used to trace the location of the card, and presumably the cardholder, as they access different areas of a secure building. Another example of a presence feed 130 is device log-in information. When a person is required to log-in to access a device and the location of the device is known, a presumption can be made that the person logging onto the device is at the device until they log off of the device. Additional examples of presence feeds 130 include scheduling calendars and instant messaging devices. Those of ordinary skill in the art will recognize that negative presence information, such as knowing that a person is not in his office or not currently in the country, may be used as a presence feed 130 to determine the location of the person making the request.

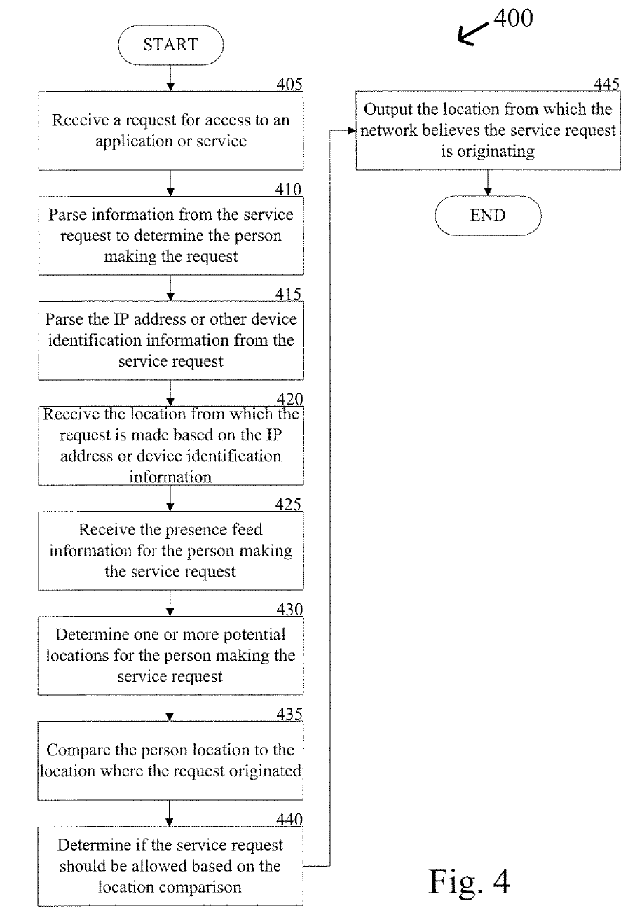

FIG. 4 presents an exemplary process 400 for determining the location from which the request to the network originated from an agent 110 as completed by the Where Logic 160 in the W3 device 105 of FIG. 1. The exemplary process 400 begins at the START step and continues to step 405, where the policy engine 165 receives a service request in the form of an XML feed from an agent 110 via the Internet 175 and passes the information in the service request to the Where Logic 160. In an alternative embodiment, the request is part of an XML feed (or any other type of known transmission feed) received by the Where Logic 160 from the agent 110 via the Internet 175. In step 410, information capable of being used to identify the person making the request is parsed from the service request. In one exemplary embodiment, this information is a security token. In another exemplary embodiment, information from the Who Logic 150 capable of identifying the person making the request can be transmitted to the Where Logic 160 either directly or through the policy engine 165. In step 415, the IP address or other information identifying the device is parsed from the service request.

Network information 125 is received by the Where Logic 160 based on the IP address or the device identification to determine the location from which the service request originated in step 420. In one exemplary embodiment, a determination is made by the Where Logic 160 as to whether the requester and the device are in the same location. For example, a global positioning system (“GPS”) places the device in the United States and provides this information to the Where Logic 160. To verify the location of the requester, a webcam electronically coupled to the GPS can be focused on the security identification card of the requester and analyzed by the Where Logic 160 to verify that the device and the requester are in the same location. In another example, the GPS unit could include a fingerprint reader. The requester as part of the request and information passed to the Where Logic 160 could provide his/her fingerprint to verify that the requester is in the same location as the GPS unit and the device.

In yet another exemplary embodiment, the requester could provide information via a phone line that is secured to a physical location (either through GPS in the phone device or the fact that the phone line is not portable (i.e. a land-line)) to the Where Logic 160. Voice biometrics from the requester are received by the Where Logic 160 and analyzed to confirm the requester is the person believed to be making the request, thereby verifying that the device and requester are in the same location. In one exemplary embodiment, verification that the requester and the device are in the same location results in a higher score with regards to the trustworthiness of the information when evaluated by the policy engine 165.

In step 425, the Where Logic 160 receives presence feed information 130 for the person that is believed to be making the request. The Where Logic 160 determines one or more potential locations for the person in step 430. In step 435, the Where Logic 160 compares the location of the person making the request to the origination of the request provided by the network information 125. The Where Logic 160 uses a set of rules to determine whether the two locations are the same or substantially similar, if the location information is trustworthy, if the presence feed information 130 is trustworthy, or if the location information is important based on the type of request and makes a initial determination of whether the request should be allowed in step 440. In one exemplary embodiment, a determination of whether the location information is trustworthy is based on the number of sources (i.e. the IP address being used, where the requester says he is located, cell-phone tower information, GPS, etc.) that place the requester in the same location. The more sources the higher the score.

In step 445, the Where Logic 160 outputs the location where the network believes the service request is originating from the agent 110 to the policy engine 165. The policy engine 165 can use the location information from the Where Logic 160 for additional processing of the service request. In one exemplary embodiment, the information provided by the Where Logic 160 to the policy engine 165 is provided in an XML feed and includes a location score and the specifics as to the location of the requester and/or the device. Additional information received or analyzed by the Where Logic 160 may also be passed to the policy engine 165 as needed. The process continues from step 445 to the END step.

The policy engine 165 is communicably connected via a distributed computer network to the agent 110, the Who Logic 150, the What Logic 155, the Where Logic 160, the application information 135, the network functions and fabric 170 in the W3 device 105 and the functions and fabric 145. The policy engine 165 obtains the facts and information behind a service request and determines what the W3 device 105 should do with those facts. The policy engine 165 includes a set of rules that are based on potential business risks and the policy engine 165 uses these rules to determine how to react to service requests based on each set of particular facts. For example, in e-commerce environments where the objective is to conduct business worldwide, the policy engine 165 may not evaluate the information from the Where Logic 160 or may not request that the Where Logic 160 conduct an evaluation. On the other hand, if the system is designed only to provide Swiss data to Swiss locations, for example, the evaluation and information from the Where Logic 160 would be of greater importance in determining whether access to the Swiss data should be granted.

The application information 135 is a repository of information regarding how an application presents data. The information in the application information 135 generally represents software-type resources, c-commerce applications, and applications that reside on devices. The policy engine 165 accesses the application information 135 in order to decide whether access or use of that application is appropriate within the enterprise. The application information 135 can also include rules defining accessibility to particular applications. For example, for each application, the application information 135 advertises to the policy engine 165 the types of devices with which the particular application can interface.

The policy engine 135 can use the application information as well as the device information from the What Logic 155 to decide if access should be denied because the service request was made from a device that not compatible with the application or if access should be granted. In addition, the policy engine 165 can access a data transformation engine 184 in the network functions and fabric 170 to determine whether the data being requested by the service request can be transformed into something that can interface with the device making the service request. For example a service request from a personal data assistant (“PDA”) device may ask for information that is generally meant to be presented on a personal computer monitor. The policy engine 165 can ask the data transformation engine 184 to determine whether the data can be transformed into a type suitable for display on the PDA. If it is not capable of transformation, the policy engine 165 can reject the service request, otherwise it can have the data transformed by the data transformation engine 184 and transmitted to the PDA. In another example, the data transformation engine 184 could be used to make some data anonymous while not making changes to other data. For example, if information is being requested from outside of a hospital building, the social security numbers that are incorporated into that data could be converted to asterisks so that the agent 110 making the service request would not be able to determine the social security numbers. In one exemplary embodiment, the output of the policy engine 165 is the configurations of the standard network components.

In addition, the policy engine 165 has the capability to dynamically change the controls or rights access to applications or information when changes are sensed or detected in the Who 150, What 155, or Where 160 logic. For example, if the Who Logic 150 is receiving face recognition or other bio-related information as part of its analysis on whether to allow access, when the face changes in front of the camera supplying the face recognition data, the policy engine 165 could change the data translation of information being presented from social security numbers to asterisks, or the policy engine 165 could stop access to the data or application altogether. In another example, as the What Logic 155 continues to monitor a device currently receiving access to data in the protected network or environment, if the What Logic 155 senses or notices a change in the device, such as a USB device being plugged in, the policy engine 165 would receive that information from the What Logic 155 and the policy engine 165 could prevent further access to that data. In yet another example, if a private banker is permitted access to Swiss data while the banker is inside of Switzerland and the banker travels across the border to Germany, the change in location can be detected (such as through the use of cell-phone or global positioning system data on a Global System for Mobile (“GSM”) communications network) and the Where Logic 160 or policy engine 165 could stop access to the Swiss data. In addition, other changes in the W3 105 environment, such as changes to the information being analyzed by the Who 150, What 155, or Where 160 Logic that have not been specifically discussed may have an immediate and dynamic effect on the configuration and control of the data flow out of the data center 145.

The agent 110 is communicably connected via a distributed computer network, such as, for example, the Internet 175, to the policy engine 165. The exemplary agent 110 provides machine state and operating system level information for the device making the service request to the policy engine 165. In an alternative embodiment, the machine state and operating system level information of the device making the service level request can be obtained through the use of a probe instead of an agent 110. The network functions & fabric 170 is communicably connected to the policy engine 165. In one exemplary embodiment, the network functions & fabric 170 includes conventional technologies such as firewalls 182, data transformation engines 184, malware prevention devices 186, network optimization engines 188 and virtual private networks 180, 190 (“VPN”) that are well-known to those of ordinary skill in the art. The functions & fabric 140 is communicably connected via a distributed computer network to the policy engine 165. The functions & fabric represents the data centers in the enterprise architecture.

The policy engine 165 is capable of receiving any combination of Who 150, What 155, and Where 165 Logic as necessary to determine whether a requester should have access to the system. For example, a Swiss banker attempts to access personal information over a remote access solution in which the rules of the policy engine 165 state that the connection and data must only be accessed within the Swiss national borders. The who information is determined by the Who Logic 150 through the use of a security identification and a 3G SN issued to the banker, which is identified by call line identification on connection to the remote access termination point. In addition, the 3G service provider provides the Where Logic 160 an XML feed locating the 3G card's location by use of cell triangulation on a regular ongoing basis. The What Logic 155 receives identification feed information of the device in use, including device characteristics such as fingerprinting of the CPU. As the device is connected to the network, information related to who, what, and where is built-up and sent onto the policy engine 165 by each of the logic components 150, 155, and 160 and the policy engine 165 allows access to the network. Since the banker is on a train, the location of the banker and the device is constantly changing. As soon as the location is outside of the Swiss borders, the location information is provided by the Where Logic 160 to the policy engine 165, which closes the connection and informs the user that the connection has been terminated.

This above example could also be extended to the Who Logic 150. A webcam on the device provides a view of the banker. Face recognition software is accessed by the Who Logic 150 to verify the identity of the banker. The identity information is provided by the Who Logic 150 to the policy engine 165, which maintains an open connection to the network so long as the banker is in front of the webcam. As soon as the banker is not in view of the webcam and/or another person is in view of the webcam the chance in identity of the lack of an ability to identify the requester (in the case where nobody is in view of the webcam) is passed from the Who Logic 150 to the policy engine 165, which closes the connection to the network.

In yet another example, a requester could attempt to access patient information from a hospital network. The rules of the policy engine or the data requested set forth that unless the requester is located within the hospital building, using, for example, WiFi triangulation, the data being sent is made anonymous, even if the requester and the device are authenticated. For example, if the Where Logic 160 determines that the requester and device are located in the hospital, the location information is provided to the policy engine 165, which provides the requester with access to the patient records and includes the social security number of the patient. However, once the Where Logic 160 determines that the requester or device are no longer located in the hospital, the new location information is provided to the policy engine 165 which automatically makes anonymous the information provided to the requester, including, for example, providing X's in place of the social security number of the patient for the patient record being requested.

While the invention is susceptible to various modifications and alternative embodiments, exemplary embodiments have been shown by way of example in the figures and have been described herein. However, it should be understood that the invention is not intended to be limited to the exemplary embodiments disclosed. Rather, the intention is to cover all modifications, equivalents, and alternatives falling within the spirit and scope of the invention as described.

I claim:

1. A computer-implemented method for dynamically evaluating access by a requester to a computer network, comprising the steps of:
receiving a request for access to the network from a requester at a device;
receiving authentication information for the requester;
accepting authorization information for the requester;
comparing the authentication information to authorization information to determine whether the requester is authentic;
generating an authentication score based on the comparison of the authentication information to the authorization information; and
determining network access based on the authentication score.

2. The computer-implemented method of claim 1, further comprising the steps of:
granting the requester access to the network at the device;
providing the requester access to the network at the device;
receiving additional authentication information for the requester;
identifying a change in the authentication information for the requester, wherein at least a portion of the additional authentication information is different than the authentication information; and
determining whether to terminate access to the network for the requester at the device based on said change.

3. The computer-implemented method of claim 1, wherein the authentication information comprises two-factor authentication information.

4. The computer-implemented method of claim 3, wherein the two-factor authentication information comprises a security identification and a personal identification number.

5. The computer-implemented method of claim 1, wherein the authentication information comprises biometric data of the requester.

6. The computer-implemented method of claim 1, wherein comparing the authentication information to the authorization information comprises:
determining whether the authentication information is substantially similar to the authorization information; and
generating the authentication score based on the similarity of the authentication information to the authorization information.

7. The computer-implemented method of claim 1, wherein comparing the authentication information to the authorization information comprises:
determining the identity of the requester based on the authentication information;
determining a service requested by the requester in the network; and
determining whether the requester is authorized to access the service on the network by comparing the identity of the requester to a listing of users permitted to access the service.

8. The computer-implemented method of claim 7, wherein the service comprises an application on the network.

9. A computer-implemented method for dynamically evaluating access by a device to a computer network, comprising the steps of:
receiving a request for access to the network from a device;
receiving information about the device making the request;
comparing the device information to historical device information;
determining whether the device is authentic based on the comparison of the device information to the historical device information;
generating an authentication score based on the comparison of the device information to historical device information; and
determining whether to grant network access to the device based on the authentication score.

10. The computer-implemented method of claim 9, wherein determining whether to grant network access to the device based on the authentication score comprises:
evaluating the authentication score;
evaluating at least a portion of the comparison of the device information to the historical device information; and
determining whether to grant network access to the device based on the authentication score and the portion of the comparison of device information to the historical device information.

11. The computer-implemented method of claim 9, further comprising the steps of:
granting the device access to the network;
providing the device access to the network;
receiving additional device information for the device while the device is accessing the network;
identifying a change in the device information, wherein at least a portion of the additional device information is different than the device information; and
determining whether to terminate access to the network for the device based on the change.

12. The computer-implemented method of claim 9, wherein the information about the device comprises fingerprint data of the device.

13. The computer-implemented method of claim 9, wherein determining whether the device is authentic comprises the steps of
determining whether the device information is substantially similar to the historical device information; and
generating the authentication score based on the amount of similarity between the device information and the historical device information.

14. The computer-implemented method of claim 9, further comprising the steps of:
determining a service requested by the device in the network;
evaluating a set of rules related to the requested service to determine whether authentication of the device is required for the requested service; and
granting access to the service on the network without evaluating the authentication score if it is determined that authentication of the device is not required for the requested service.

15. The computer-implemented method of claim 14, further comprising the step of:
evaluating the authentication score to determine whether to grant network access if it is determined that authentication is required for the requested service.

16. the computer-implemented method of claim 14, wherein the service comprises an application on the network.

17. A computer-implemented method for dynamically evaluating access by a device to a computer network, comprising the steps of:
receiving a request for access to the network from a requester at a device;
receiving a device location;
receiving a requester location;
comparing the location of the device to the location of the requester to determine whether they are substantially similar; and
granting access to the network at the device based on a positive determination that the device location and the requester location are substantially similar.

18. The computer-implemented method of claim 17, further comprising the steps of:
determining a service requested by the device in the network;
evaluating a set of rules related to the requested service to determine whether determining the location of the device or the requester is required for access to the service; and
granting access to the service on the network without regard to the comparison of the location of the device to the location of the requester based on a determination that determining the location of the device or the requester is not required for access to the service.

19. The computer-implemented method of claim 17, further comprising the steps of:
determining a service requested by the device in the network;
evaluating a set of rules related to the requested service to determine a location where the service can be accessed;
determining whether the location of the device is within the location where the service is allowed to be accessed; and
providing the device access to the service on the network based on a positive determination that the location of the device is within the location where the service is allowed to be accessed.

20. The computer-implemented method of claim 19, further comprising the steps of:
receiving additional device location information while the device is accessing the service on the network;
identifying a change in the location of the device based on a difference between the device location and the additional device location information;
determining whether the location of the device is within the location where the service is allowed to be accessed based on the additional device location information; and
determining whether to terminate access to the service based on the additional device location information.

21. The computer-implemented method of claim 17, further comprising the steps of:
determining a service requested by the device in the network;
evaluating a set of rules related to the requested service to determine a location where the service can be accessed;
determining whether the location of the requester is within the location where the service is allowed to be accessed; and
providing the device access to the service on the network based on a positive determination that the location of the requester is within the location where the service is allowed to be accessed.

22. The computer-implemented method of claim 21, further comprising the steps of:
receiving additional requester location information while the device is accessing the service on the network;
identifying a change in the location of the requester based on the additional device location information;
determining whether the location of the requester is within the location where the service is allowed to be accessed based on the additional requester location information; and
determining whether to terminate access to the service based on the additional requester location information.

23. The computer-implemented method of claim 17, wherein the requester location is determined from presence feeds.

24. The computer-implemented method of claim 17, wherein the device location is determined from a global positioning system signal.

25. The computer-implemented method of claim 17, wherein receiving the device location comprises:
accepting an internet protocol address for the request;
evaluating the internet protocol address to determine a location of the internet protocol address;
assigning the location of the internet protocol address as the device location.

26. The computer-implemented method of claim 17, further comprising the steps of:
determining the identity of the requester comprising the steps of:
receiving authentication information for the requester;
accepting authorization information for the requester;
comparing the authentication information to the authorization information to determine whether the requester is authentic;
identifying the requester based on a positive determination that the requester is authentic.

27. The computer-implemented method of claim 17, wherein receiving the requester location comprises the steps of:
receiving the device location, wherein the device comprises a webcam;
receiving a video feed of at least a portion of the requester from the webcam;
determining the identity of the requester based on the video feed; and
setting the location of the requester as equal to the device location.

28. The computer-implemented method of claim 17, wherein receiving the requester location comprises the steps of:
receiving the device location;
receiving a biometric data of the requester at the device;
evaluating the biometric data to determine the identity of the requester; and
setting the location of the requester as equal to the device location.

29. The computer-implemented method of claim 17, further comprising the steps of:
generating a location score based on the similarity in location information for the device and the requester; and
determining whether to grant network access to the device based on the location score.

30. The computer-implemented method of claim 29, wherein the location score improves based on increase in the number of location source providers that identify that the requester and the device are in a substantially similar location.

31. A system for dynamically evaluating access by a device to a computer network comprising
a first logic component for receiving information about a requester using the device and determining the authenticity of the requester;
a second logic component for receiving information about the device making a request to access the network and determine whether the device is authentic; and
a third logic component for receiving information about a location of the device and a location of the requester and determining whether the locations of the device and the requester are substantially similar.

32. The system of claim 31, further comprising a policy engine for receiving the determinations of the first, second, and third logic components and determining whether to grant the device access to the network based on those determinations.

33. The system of claim 32, wherein the policy engine further receives at least a portion of the information about the location of the device and the location of the requester and determining whether to grant the device access to the network further comprises an evaluation of the received portion of the information about the location of the device and the location of the requester.

34. The system of claim 32, wherein the policy engine receives updated information from at least one of the first, second, and third logic components while the device is accessing the network, wherein the updated information is analyzed by the policy engine to identify differences between the updated information and the information from the first, second, and third logic components.

35. The system of claim 34, further comprising a plurality of applications, at least a portion of the applications comprising access rules, wherein the policy engine evaluates the access rules for an application requested by the device and terminates the connection between the device and the network if the difference between the updated information and the information from the first, second, and third logic components violates at least one of the access rules for the requested application.

36. The system of claim 31, further comprising presence feeds communicably connected to the third logic component, wherein the presence feeds comprise information about the location of the requester.

37. The system of claim 31, further comprising an authorization repository communicably connected to the first logic component, wherein the authorization database comprises user permission information for a plurality of services on the network.

38. The system of claim 31, further comprising a repository of device assets communicably connected to the second logic component, wherein the repository comprises information about a plurality of devices having access to the network.

39. The system of claim 31, wherein the first, second, and third logic components are comprised in a single logic component.

40. A computer-implemented method for dynamically evaluating access by a requester to a computer network, comprising the steps of:
determining a first authentication information for the requester at a first period in time;
determining a second authentication information for the requester at a second period in time while the requester is accessing the network;
comparing the first authentication information to the second authentication information;
identifying a change between the first and second authentication information for the requester; and
determining whether to terminate the requester's access to the network at the device based on the change.

41. The computer-implemented method of claim 40, wherein determining whether to terminate the requester's access to the network at the device is based on an evaluation of the second authentication information.

42. The computer-implemented method of claim 40, further comprising the step of granting the requester access to the network at the device based on the first authentication information.

43. A computer-implemented method for dynamically evaluating access by a device to a computer network, comprising the steps of:
receiving a first set of information about the device making the request at a first period of time;
receiving a second set of information about the device at a second period of time, while the device is accessing the network;
comparing the first set of information about the device to the second set of information about the device;
identifying a change between the first and second set of information; and
determining whether to terminate the device's access to the network based on the change.

44. The computer-implemented method of claim 43, wherein determining whether to terminate the device's access to the network is based on an evaluation of the second set of information about the device.

45. The computer-implemented method of claim 43, further comprising the step of granting the device access to the network based on the first set of information about the device.

46. A computer-implemented method for dynamically evaluating access by a device to a computer network, comprising the steps of:
receiving a first location for the device at a first period of time;
receiving a second location for the device at a second period of time, while the device is accessing the network;
comparing the first location to the second location;
identifying a change between the first and second location of the device; and
determining whether to terminate the device's access to the network based on the change.

47. The computer-implemented method of claim 46, wherein determining whether to terminate the device's access to the network is based on an evaluation of the second location for the device.

48. The computer-implemented method of claim 46, further comprising the step of granting the device access to the network based on the first location for the device.

49. A computer-implemented method for dynamically evaluating access by a requester at a device to a computer network, comprising the steps of:
receiving a first location for the requester at a first period of time;
receiving a second location for the requester at a second period of time, while the device is accessing the network;
comparing the first location to the second location of the requester;
identifying a change between the first and second location of the requester; and
determining whether to terminate access to the network based on the change.

50. The computer-implemented method of claim 49, wherein determining whether to terminate access to the network is based on an evaluation of the second location for the requester.

51. The computer-implemented method of claim 49, further comprising the step of granting the requester access to the network at the device based on the first location for the requester.

52. A system for dynamically evaluating access by a device to a computer network comprising:
a first logic component for receiving information about a requester using the device and determining the authenticity of the requester;
a second logic component for receiving information about the device making a request to access the network and determine whether the device is authentic;
a third logic component for receiving information about a location of the device and a location of the requester and determining whether the locations of the device and the requester are substantially similar;
a policy engine for receiving information from at least one of the first, second, and third logic components at a first period of time and updated information from at least one of the first, second, and third logic components at a second period of time, while the device is accessing the network, wherein the information and the updated information are compared to identify a change and a determination is made whether to terminate access by the device to the network based on the change.
